(19) United States
(12) Patent Application Publication
(10) Pub. No.: US 2002/0011395 A1
(43) Pub. Date: Jan. 31, 2002

(54) Transferring device on a press

(76) Inventor: Rudolf Luthi, Niederwangen (CH)

Correspondence Address: MORGAN, LEWIS & BOCKIUS, 1800 M STREET NW, WASHINGTON, DC, 20036-5869, US

(21) Appl. No.: 09/826,417

(22) Filed: Apr. 5, 2001

Related U.S. Application Data
(63) Continuation of application No. PCT/CH99/00464, filed on Sep. 30, 1999.

(30) Foreign Application Priority Data
Oct. 5, 1998 (CH) 2024/98

(51) Int. Cl. B65G 25/00

(52) U.S. Cl. 198/339.1

(57) ABSTRACT

The invention relates to a device for progressively transporting workpieces in a longitudinal direction from a receiving station, through at least one processing station of a press, including transporters for the workpieces, where the transporters are moved back and forth in a longitudinal direction, cyclically and in synchrony with the movement of the slide of the press, and in a crosswise direction perpendicular to the longitudinal direction for picking up and releasing the workpieces. The transporter may be driven in the longitudinal direction by an external drive that is synchronized with the eccentric shaft of the press by signaling. The movement of the transporters for releasing the workpieces in the crosswise direction is derived from the movement of the press slide by direct mechanical coupling.

This application claims the benefit of priority under 35 U.S.C. §365(c) to International Application No. PCT/CH99/00464, whose international filing date is Sep. 30, 1999, and this application hereby incorporates said International Application in its entirety by reference thereto.

### BACKGROUND OF THE INVENTION

1. Field of the Invention

The present invention relates to an apparatus on a press for the stepwise transportation of workpieces in a longitudinal direction from a receiving station through at least one processing station of the press, having transporting means for the workpieces which are moved back and forth cyclically and synchronously with the movement of the press in the longitudinal direction and, in order to grasp and/or release the workpieces again, in a transverse direction perpendicular to the longitudinal direction. Such apparatuses are also referred to as transfer apparatuses. In relation to so-called follow-on composite tools, transfer apparatuses are distinguished in that the part which is to be formed in the press, in the region of the receiving station, is first of all severed, for example, from an endless strip, e.g. by being cut off or punched out, and is then transported through the at least one processing station of the press independently of the movement of the endless strip, and usually also perpendicularly thereto. The press is usually provided with a plurality of processing stations and/or forming stages arranged one behind the other. In the case of the follow-on composite tools, in contrast, the part which is to be formed is transported from forming stage to forming stage by way of the dedicated endless strip from which it originates.

2. Description of the Related Art

A transfer apparatus of the type mentioned, having a pair of transporting bars as transporting means for the workpieces, is known, for example, from EP 0 490 821 A1. In this document, the transporting bars are driven by mechanical coupling to moving parts of the press, to be precise, in the longitudinal direction, by taking the movement from the eccentric shaft of the press via a gear mechanism and, in the transverse direction, by taking the movement from the ram of the press by means of control rails, as a result of which it is possible to realize high numbers of strokes in the region of 300 strokes per minute. For specific applications in the can sector, even up to 700 strokes per minute are achieved. The mechanical coupling also makes it possible for collisions of the press tool with the transporting means to be prevented to the greatest possible extent.

Apparatuses which are similar in principle are known from EP 0 504 098 A1 and EP 0 694 350 A1, the transporting bars and the workpieces here also having a superposed vertical movement.

Also known are transfer apparatuses in which the transporting means are driven via one or more external drives using servomotors, hydraulics, pneumatics, linear motors, etc. and which are synchronized by signal in a wide range of different ways with the movement of the press ram. U.S. Pat. No. 4,462,521 is an example of this. Such external drives can usually be used less expensively, and also more flexibly, than the above-mentioned mechanical couplings, but they cannot achieve such high numbers of strokes. The limit here, at present, is 50-150 strokes per minute. In addition, in the event of a drive failing, there is the risk of a collision between the press tool and the transporting means with usually destructive consequences.

### DESCRIPTION OF THE INVENTION

The invention, as is characterized in patent claim 1, combines the advantages of the previously known solutions while largely avoiding their respective disadvantages. The invention thus uses an external drive only for driving the transporting means in the longitudinal direction and, if appropriate, also in the transverse direction for grasping the workpieces, while, for driving these means in the transverse direction during the phase in which the workpieces are released again, it is based on a direct mechanical coupling or positive guidance with the movement of the press and in this case, in particular, directly with the press ram. Surprisingly, this drive combination can achieve numbers of strokes which, rather than being significantly restricted by the at least one external drive used, correspond approximately to those achieved by purely mechanical direct drives.

The invention is based on the finding that, if drive means for the transporting means fail, it is only those drive means which cause the transverse movement associated with the release of the workpieces which are actually critical. This is because failure of the movement associated with the release inevitably results in a collision between the transporting means and the forming tool, which usually means that the latter is damaged or even destroyed.

Failure of the longitudinal drive in this respect, in contrast, is less critical since, as long as the mechanism responsible for releasing the workpieces again is functioning, the transporting means cannot collide with the forming tool. This case of disruption causes damage, at most, to one workpieces or a limited number of workpieces. The same applies to the transverse drive of the transporting means, which causes the workpieces to be grasped.

By virtue of the invention, in respect of the transverse drive of the transporting means for releasing the workpieces again, being based on a mechanical coupling to the movement of the press, it reliably avoids the critical cases of disruption which may result in damage to, or destruction of, the usually very expensive forming tool. By virtue of the invention also, in respect of the rest of the movement components and in this case at least in respect of the longitudinal drive of the transporting means, using an external drive, it expediently utilizes a considerable potential for saving since external drives such as those of the above-mentioned type are considerably more cost-effective to realize than the gear mechanisms normally used for the mechanical coupling of the longitudinal movement of the transporting means to the movement of the eccentric shaft of the press. These gear mechanisms are expensive components, inter alia, because they have to be inherently very rigid in order to avoid vibrations. On account of the position and design of the eccentric shaft, which vary, in some cases, greatly from press type to press type, these gear mechanisms additionally have to adapted to the respective machine type, which does not allow a universal transfer-apparatus design irrespective of the respective machine type. If, in a certain press, it is only the length of the longitudinal steps which is intended to be changed, the gear mechanism for the longitudinal advancement frequently has to be exchanged in its entirety. With an external drive of the above-mentioned type, in contrast, it is possible for the longitudinal advancement to be varied within certain limits, without any mechanical modifications, and adjusted flexibly to the respective requirements simply by a change in the external-drive activation. It is also the case here that adaptation to different press types does not pose any problem.

The mechanical coupling of the transporting means to the movement of the press exclusively for realizing the transporting-means transverse drive which is responsible for releasing the workpieces again, on the other hand, is not associated with any significant complexity and cost because this coupling can be released extremely easily, for example, directly via control rails which are provided with a suitable cam. This is possible on account of the distances in the transverse direction only being comparatively small in relation to the stroke of the press ram, with the result that the corresponding cams only have to have a gentle slope. In the longitudinal direction, in which the distances which have to be covered during each stroke are greater by a factor of 4-5 in comparison, such a straightforward mechanical coupling is not possible, for which reason the above mentioned high-outlay gear mechanisms have also always been used here up until now.

As has already been mentioned, the apparatus according to the invention makes it possible to operate with considerably higher numbers of strokes than is the case using systems that use external drives both for the longitudinal movement and the transverse movement. Up to 270 strokes per minute has already been achieved by an apparatus according to the invention. In the case of the apparatus according to the invention, the number of strokes is thus not significantly restricted, if at all, by the external drive or drives used. This is based, inter alia, on the fact that the transporting means are more sensitive to vibration in the transverse direction than in their longitudinal direction. On account of the mechanical coupling between the transporting means and the forming tool or tools in the transverse direction, however, only very small interspaces have to be maintained in this direction. It is also the case that there is no need to take account of contouring errors, as arise in external drives. This means that there is no overshooting in practice in the transverse movement and, overall, the transverse movement of the transporting means proceeds very smoothly and with a low level of vibration.

In comparison with fully externally controlled systems, the invention also increases the process reliability since the external drive of one axis is dispensed with. As a new tool is run in, it is not possible for a programming error to cause any significant damage. Preferred configurations of the invention are characterized in the dependent claims.

### BRIEF DESCRIPTION OF THE DRAWINGS

The invention will be explained in more detail hereinbelow with reference to an exemplary embodiment and in conjunction with the drawing, in which:

FIG. 1 shows a plan view of the table of a press with a transfer apparatus,

FIG. 2 shows an end view of the press with parts of the transfer apparatus,

FIG. 3 shows, on an enlarged scale, a partial section along line III-III in FIG. 1, and

FIG. 4 shows part of the longitudinal drive of the transfer apparatus.

### DESCRIPTION OF THE PREFERRED EMBODIMENT

Reference will now be made in detail to the present exemplary embodiments of the invention illustrated in the accompanying drawings. Whenever possible, the same reference numbers will be used throughout the drawings to refer to the same or like parts.

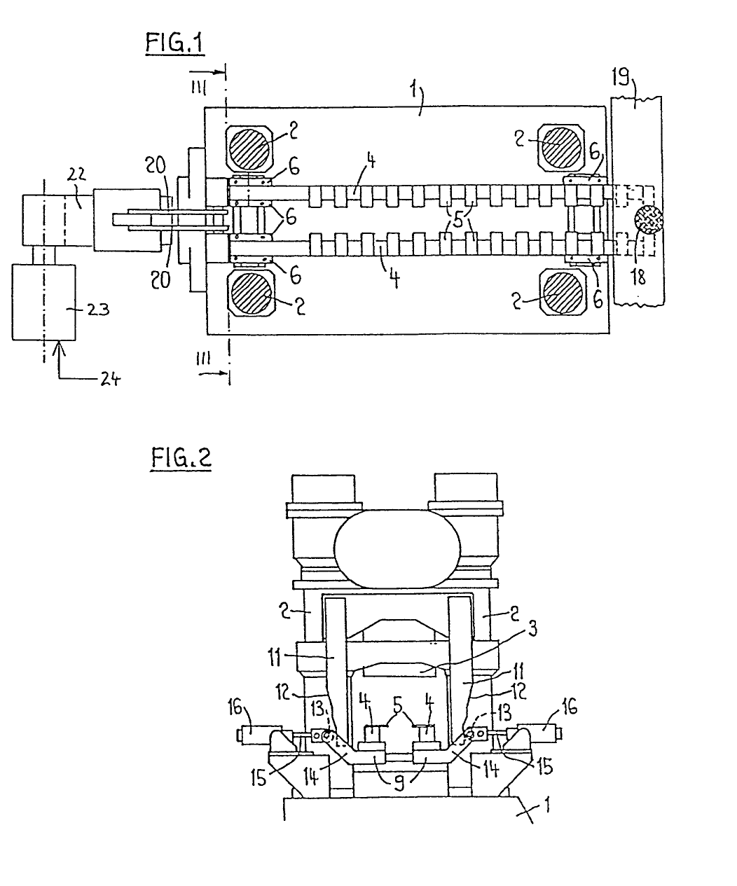

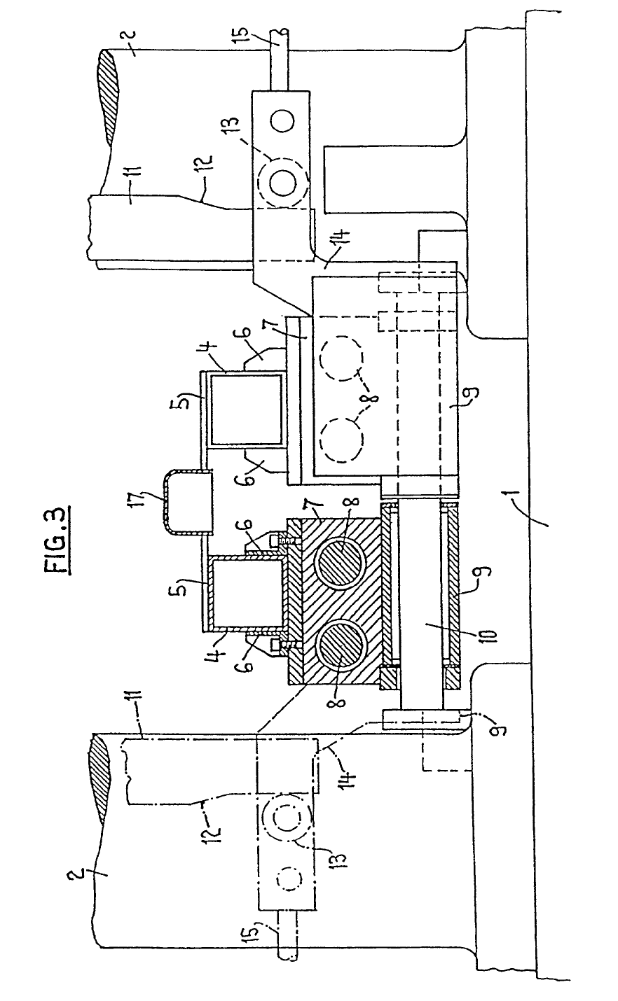

FIGS. 1 and 2 show, more or less schematically, a press table 1, guide columns 2 and a press ram 3. Fastened in the customary manner in the table 1 is the bottom part, and on the ram 3 the top part, of a so-called transfer tool with a plurality of processing or forming stations arranged one behind the other. In order to simplify matters, this tool is not illustrated in the drawing. As the transporting means in the longitudinal direction, through the individual forming stations, for the workpieces which are to be formed, in each case one transporting bar 4 with grippers 5 (which are purely schematically illustrated) for the workpieces are located on both sides of the tool. The ends of the transporting bars are fitted on longitudinal carriages 7 by means of fastening angles 6. The longitudinal carriages 7 (FIG. 3) are guided rigidly along two parallel guide bars 8 which, for their part, are fastened in a transverse carriage 9 which is guided along two parallel transverse guide bars 10.

The movement of the transporting bars 4 transversely outward in the opening direction is controlled via a mechanical cam system which incorporates control rails 11 with cams 12 and control rollers 13. The control rails 11 are fitted on the press ram 3 and act by way of their cams 12, which are located on the outside, on the control rollers 13 of continuations 14 of the carriages 9. The piston rods 15 of pneumatic cylinders 16, on the other hand, act in the reverse direction, inward, on the continuations 14. This means that there is always reliable contact pressure acting inward on the continuations 14 in the closing direction, with the result that it is also always the case that the control rollers 13 butt reliably against the cams 12 of the control rails 11. It can be seen from FIGS. 2 and 3 that, with the downward movement of the control rails 11 with the press ram 3, the control rollers 13 and the parts connected thereto, i.e. also the transporting bars 4, are spread apart in the outward direction, thus releasing a workpiece 17 clamped between two opposite holders 5. The holders 5 are also moved away laterally from the region of the top and bottom tool parts of the press, with the result that the tool can be closed for processing workpieces in all stations.

It is indicated in FIG. 1 that, in a punching and receiving station, workpieces, e.g. blanks 18, are punched out of a strip 19, which runs through transversely, and are received by the outermost grippers of the transporting bars 4. In successive operating cycles, the workpieces 18 are displaced to the left in a stepwise manner and thus fed one after the other to the individual forming stations of the transfer tool. Following a certain initial period, all the forming stations are provided with in each case one workpiece 18. During each operating cycle, the transporting bars 4 execute a continuous rectangular movement, in that in a first step they advance a number of grasped blanks to the next-following forming station of the transfer tool, in a second step they are moved away laterally outward from the workpieces and from the region of overlap with the tool, in a third step they are guided back again in the longitudinal direction, and in a fourth step they are moved inward in the direction of the tool again in order to grasp the workpieces.

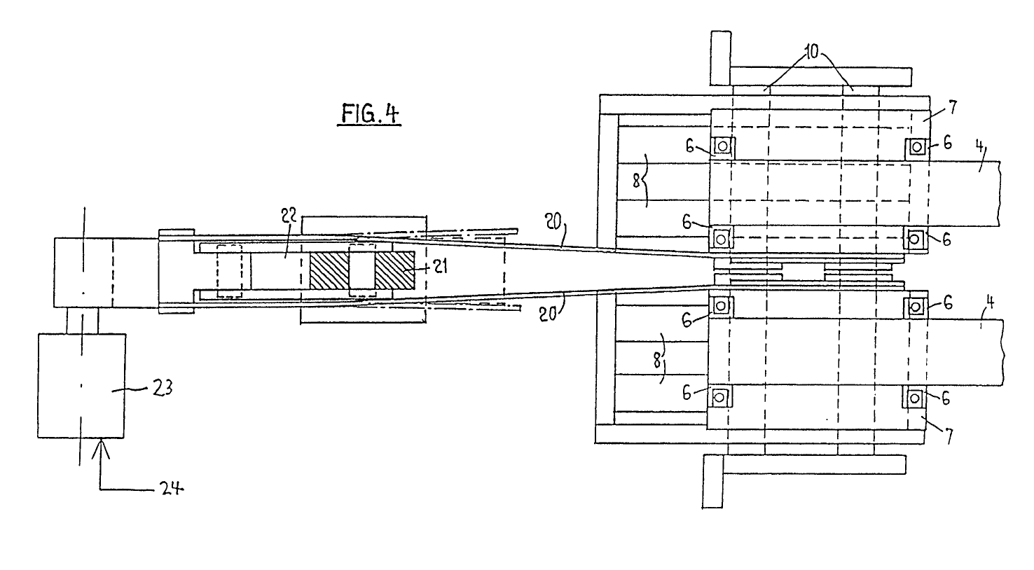

The longitudinal drive of the transporting bars 4 comprises two leaf springs 20 which are fastened, by way of their right-hand ends, on the inside of the longitudinal carriages 7 and which, as in indicated in FIG. 4, can follow the transverse movements of the transporting bars 4. At their left-hand end, the two leaf springs 20 are connected to a guide carriage 21 which can be moved back and forth in the longitudinal direction and is driven by an electric servomotor 23 via a toothed belt 22. The servomotor 23 receives a control signal 24 that is derived from the movement of the eccentric shaft of the press by way of a rotary encoder (not illustrated).

Instead of the servomotor 23 it would be just as possible to use a hydraulic motor or a linear motor. Finally, instead of a motor and the toothed belt 22, it would also be possible simply for a pneumatic cylinder or a hydraulic cylinder to be used.

It will be apparent to those skilled in the art that various modifications and variations can be made without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. Apparatus on a press for the stepwise transportation of workpieces in a longitudinal direction from a receiving station to at least one processing station of the press, it being the case that the apparatus has transporting means for the workpieces which are moved back and forth cyclically and synchronously with the stroke movements of the press, to be precise, on the one hand, in the longitudinal direction and, on the other hand, in order to grasp and/or release the workpieces again, in a transverse direction perpendicular to the longitudinal direction, and it being the case that mechanical coupling means are provided between the press and the transporting means in order for the movement of the transporting means for releasing the workpieces in the transverse direction to be coupled directly in a mechanical manner to the stroke movements of the press, wherein the apparatus comprises a first external drive that provides for the movement of the transporting means in the longitudinal direction and is substantially synchronized with the stroke movements of the press and, in terms of the length of the transporting steps brought about by it, can be varied within certain limits, without any mechanical changes, solely via activation.

2. The apparatus according to claim 1, further comprising a second external drive that is provided for moving the transporting means for gripping the workpieces in the transverse direction.

3. The apparatus according to claim 1, wherein the first external drive comprises a servomotor, a linear motor, a hydraulic motor, a hydraulic cylinder or a pneumatic cylinder.

4. The apparatus according to claim 2, wherein the second external drive comprises a servomotor, a linear motor, a hydraulic motor, a hydraulic cylinder or a pneumatic cylinder.

5. The apparatus according to claim 1, further comprising a rotary encoder which produces a signal representing the rotary position of an eccentric shaft of the press, and in that the first external drive, for moving the transporting means in the longitudinal direction, is exposed to the signal and controlled by the signal.

6. The apparatus according to claim 1, wherein the apparatus can be used to achieve up to 270 strokes per minute.

7. The apparatus according to claim 1, wherein the press comprises a press ram which executes the stroke movements, and the drive of the transporting means for releasing the workpieces in the transverse direction is derived from the stroke movements of the press ram via a mechanical cam system.

8. The apparatus according to claim 1, wherein the transporting means comprise transporting bars which extend in the longitudinal direction on both sides of the receiving station and of the at least one processing station and are provided preferably with grippers for gripping the workpieces.
